(19) United States
(12) Patent Application Publication
(10) Pub. No.: US 2017/0031223 A1
(43) Pub. Date: Feb. 2, 2017

(54) ARRAY SUBSTRATE, LIQUID CRYSTAL DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yanna Xue, Beijing (CN); Xiaochuan Chen, Beijing (CN); Wenbo Jiang, Beijing (CN); Lei Wang, Beijing (CN); Shijun Wang, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/033,758

(22) PCT Filed: Oct. 29, 2015
(86) PCT No.: PCT/CN2015/093227

§ 371 Date: May 2, 2016

(30) Foreign Application Priority Data
May 11, 2015 (CN) 201510236536.8

(51) Int. Cl. G02F 1/1362; G02F 1/1345

(52) U.S. Cl. CPC G02F 1/136286; G02F 1/13454; G02F 2001/13629

(57) ABSTRACT

An array substrate, a liquid crystal display panel and a display device are provided. The array substrate includes: a base substrate (1); a plurality of gate lines (2) and a plurality of data lines (3), on the base substrate, intersecting with each other and insulated from each other; and a gate electrode driving circuit (4) located on the base substrate (1), configured for providing driving signals for the respective gate lines (2). The gate electrode driving circuit (4) is located in an upper frame region or a lower frame region of the array substrate, which is conducive to reduce a width of a frame.

### TECHNICAL FIELD

Embodiments of the present disclosure relate to an array substrate, a liquid crystal display panel and a display device.

### BACKGROUND

In an existing display device, a Liquid Crystal Display (LCD) has advantages such as low power consumption, high display quality, no electromagnetic radiation, and wide range of applications, and is an important display device at present.

### SUMMARY

An embodiment of the present disclosure provides an array substrate, comprising: a base substrate, a plurality of gate lines and a plurality of data lines, on the base substrate, intersecting with each other and insulated from each other; and a gate electrode driving circuit located on the base substrate, configured for providing a driving signal for the respective gate lines, wherein, the gate electrode driving circuit is located in an upper frame region or a lower frame region of the array substrate.

Another embodiment of the present disclosure provides a liquid crystal display panel, comprising: the above-described array substrate.

A further embodiment of the present disclosure provides a display device, comprising the above-described liquid crystal display panel.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a structural schematic diagram of an related array substrate;

FIG. 2 is a structural schematic diagram of an array substrate provided by an embodiment of the present disclosure;

FIG. 3 is a structural schematic diagram of the array substrate provided by the embodiment of the present disclosure;

### DETAILED DESCRIPTION

The technical solutions of the embodiments of the present disclosure will be described in a clearly and fully understandable way in connection with the drawings. It is obvious that the described embodiments are just a part but not all of the embodiments of the present disclosure. Based on the described embodiments herein, those skilled in the art can obtain other embodiment(s), without any inventive work, which should be within the scope of the present disclosure.

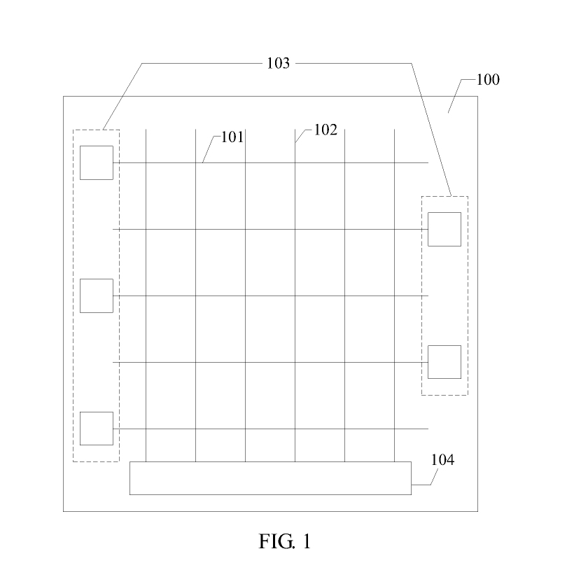

In a related art, a narrow frame or even no frame has become a development trend in a display field. In order to implement a narrow frame design for the LCD, a Gate On Array (GOA) technology of integrating a gate electrode driving circuit onto an array substrate of the LCD can be used. As shown in FIG. 1, a plurality of gate lines 101 and a plurality of data lines 102 intersecting with each other and insulated from each other are disposed on an array substrate 100. A gate electrode driving circuit 103 configured for sequentially providing gate electrode scanning signals for respective gate lines is located in a left frame region and a right frame region of the array substrate 100. Data line pins 104 for electrically connecting respective data lines with a data driving circuit are located in a lower frame region of the array substrate 100. However, the gate electrode driving circuit 103 integrated onto the array substrate 100 still occupies a certain width, which restricts development of ultra-narrow frame or no frame of the LCD.

Therefore, how to further reduce the width of the frame of the LCD is one of the technical problems to be solved by those skilled in the art.

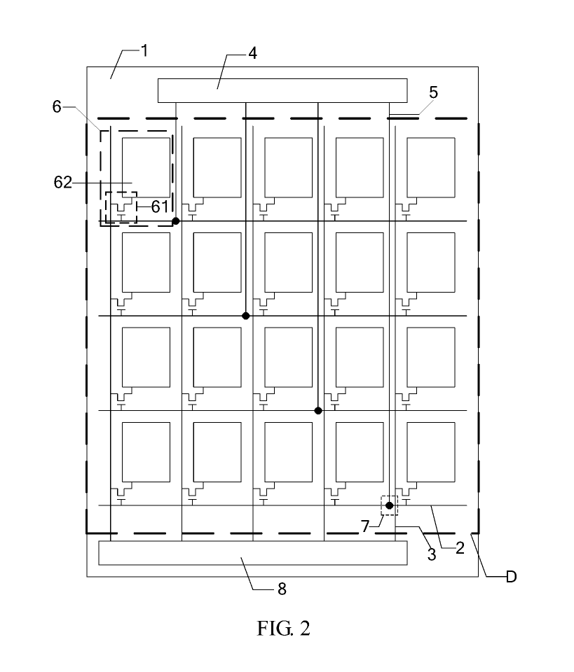

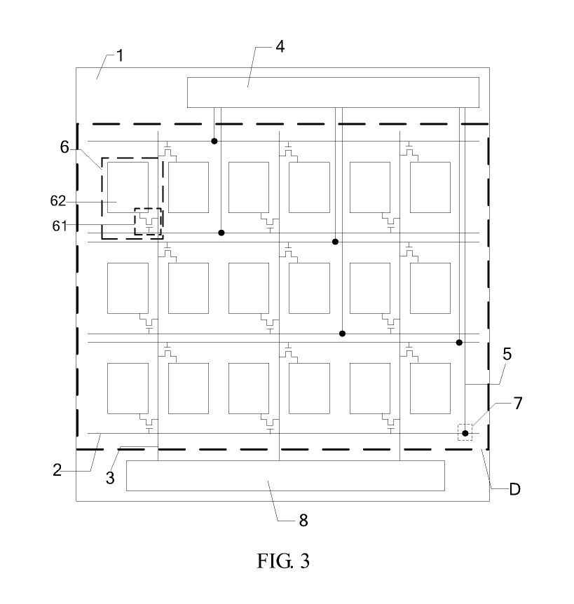

An embodiment of the present disclosure provides an array substrate, as shown in FIG. 2 and FIG. 3, including: a base substrate 1; a plurality of gate lines 2 and a plurality of data lines 3, on the base substrate 1, intersecting with each other and insulated from each other; and a gate electrode driving circuit 4 located on the base substrate 1, for driving respective gate lines 2. The gate electrode driving circuit 4 is configured for providing driving signals for the respective gate lines 2. The plurality of gate lines 2 are parallel to each other and extend in a transverse direction; and the plurality of data lines 3 are parallel to each other and extend in a longitudinal direction.

The gate electrode driving circuit 4 is located in an upper frame region (as shown in FIG. 2 and FIG. 3) or a lower frame region of the array substrate.

In the above-described array substrate provided by the embodiment of the present disclosure, because the gate electrode driving circuit is disposed in the upper frame region or the lower frame region of the array substrate, as compared with a structure in which the gate electrode driving circuit is located in the left frame region and the right frame region of the array substrate in the related art, the above-described array substrate provided by the embodiment of the present disclosure can implement a design of no left frame and no right frame. Herein, the “upper frame region” and the “lower frame region” refer to two frame regions opposite to each other in the longitudinal direction of the array substrate; and the “left frame region” and the “right frame region” refer to two frame regions opposite to each other in the transverse direction of the array substrate.

For example, the above-described array substrate provided by the embodiment of the present disclosure, as shown in FIG. 2 and FIG. 3, may further include: a plurality of connecting lines 5 electrically connected with the respective gate lines 2 in one-to-one correspondence. The respective connecting lines 5 are, for example, electrically connected with the corresponding gate lines 2 through via holes 7. The respective gate lines 2 are electrically connected with the gate electrode driving circuit 4 through the corresponding connecting lines 5, and thus, the gate electrode driving circuit 4 can sequentially provide gate scanning signals for the respective gate lines 2 through the connecting lines 5, to implement line-by-line driving of the respective gate lines 2.

Of course, in the above-described array substrate provided by the embodiment of the present disclosure, the gate electrode driving circuit located in the upper frame region or the lower frame region of the array substrate may also implement sequentially providing the gate electrode scanning signals for the respective gate lines in other similar modes, which will not be limited here.

For example, in the above-described array substrate provided by the embodiment of the present disclosure, as shown in FIG. 2 and FIG. 3, in a display region of the array substrate (a dotted-line box region indicated by a reference sign D), the respective connecting lines 5 may be parallel to the respective data lines 3; or, the respective connecting lines may be disposed intersecting with the respective data lines. Herein, in order to avoid a problem of light leakage due to the respective connecting lines, a material of the respective connecting lines may be a transparent conductive material, for example, Indium Tin Oxides (ITO) and the like.

For example, the above-described array substrate provided by the embodiment as shown in FIG. 2 of the present disclosure, may further include: a plurality of pixel units 6 arranged in a matrix on the base substrate 1. Each pixel unit 6 may include a thin film transistor 61 and a pixel electrode 62, wherein, a gate electrode of the thin film transistor 61 is electrically connected with the gate line 2, a source electrode of the thin film transistor 61 is electrically connected with the data line 3, a drain electrode of the thin film transistor 61 is electrically connected with the pixel electrode 62; two adjacent gate lines 2 and two adjacent data lines 3 define one pixel unit 6; a region occupied by all the pixel unit 6 is, for example, a display region of the array substrate. In a case where a material of the connecting line 5 is a non-transparent conductive material, for example, metal, the connecting line 5 may be disposed at a gap between two adjacent columns of pixel units 6, that is, the connecting line 5 is disposed at a gap between two adjacent columns of pixel units 6 where the data line 3 is located, and thus, the problem of light leakage due to the respective connecting lines 5 can be avoided.

It should be noted that, in the above-described array substrate provided by the embodiment of the present disclosure, If the number of the gate lines is greater than the number of the data lines, the number of the connecting lines is greater than the number of the data lines because the number of the connecting lines is equal to the number of the gate lines. In this case, a plurality of connecting lines may be disposed at a gap between two adjacent columns of the pixel units where one data line is located; If the number of the gate lines is less than the number of the data lines, the number of the connecting lines is less than the number of the data lines because the number of the connecting lines is equal to the number of the gate lines. In this case, one connecting line may be disposed at a gap between two adjacent columns of the pixel units where one data line is located, and there will be a case where no connecting line is disposed at part of the gaps where data lines are located; If the number of the gate lines is equal to the number of the data lines the number of the connecting lines is equal to the number of the data lines because the number of the connecting lines is equal to the number of the gate lines. In this case, one connecting line may be disposed at each gap where one data line is located.

For example, the above-described array substrate provided by the embodiment as shown in FIG. 3 of the present disclosure, may further include: a plurality of pixel units 6 arranged in a matrix on the base substrate 1; wherein, each pixel unit 6 may include a thin film transistor 61 and a pixel electrode 62, a gate electrode of the thin film transistor 61 is electrically connected with the gate line 2, a source electrode of the thin film transistor 61 is electrically connected with the data line 3, a drain electrode of the thin film transistor 61 is electrically connected with the pixel electrode 62; two gate lines are formed between every two adjacent rows of pixel units; two adjacent pixel units 6 in each row of pixel units 6 are respectively electrically connected with the gate lines 2 which are located on both sides of the row of the pixel units 6 and are closest to the row of pixel units 6. For example, as shown in FIG. 3, in each row of pixel units 6, the pixel units 6 in an even-numbered column are respectively electrically connected with the gate line 2 which are located above this row of pixel units 6 and are closest to this row of pixel units 6 through the gate electrodes of their respective thin film transistors 61; the pixel units 6 in an odd-numbered column are respectively electrically connected with the gate lines 2 which are located below this row of pixel units 6 and are closest to this row of pixel units 6 through the gate electrodes of their respective thin film transistors 61. Two adjacent columns of pixel units 6 are electrically connected with a same data line 3. For example, as shown in FIG. 3, a first column of pixel units 6 and a second column of pixel units 6 are both electrically connected with the data line 3 located at the gap between the two adjacent columns of pixel units; In the case where the connecting line 5 is made of an non-transparent conductive material, for example, metal, the connecting line 5 can be disposed at the gap between two adjacent columns of pixel units 6 where the data line 3 is disposed, so as to avoid the problem of light leakage due to the respective connecting lines 5. Furthermore, in order to avoid mutual interference between the gate electrode scanning signal on the connecting line 5 and a gray-scale signal on the data line 3, as shown in FIG. 3, the connecting line 5 can be disposed at a gap between two adjacent columns of pixel units 6 where none of the data lines 3 is disposed.

It should be noted that, the above-described array substrate provided by the embodiment of the present disclosure, the structure for connecting two adjacent pixel units in each row of pixel units are respectively electrically connected with the gate lines located on both sides of this row of pixel units is not limited to the structure as shown in FIG. 3. In each row of pixel units, the pixel units in the odd-numbered column may also be electrically connected with the gate line located above this row of pixel units, and the pixel units in the even-numbered column may also be electrically connected with the gate line located below this row of pixel units, which will not be limited here.

It should be noted that, in the above-described array substrate provided by the embodiment as shown in FIG. 3 of the present disclosure, in the case where the number of the gate lines is greater than the number of the gaps between the two adjacent columns of pixel units where none of the data lines is disposed, the number of the connecting lines is greater than the number of the gaps between the two adjacent columns of pixel units where none of the data lines is disposed (i.e., positions used for disposing the connecting lines), because the number of the connecting lines is equal to the number of the gate lines. In this case, a plurality of connecting lines may be disposed at one gap where none of the data lines is disposed. In the case where the number of the gate lines is less than the number of the gaps between the two adjacent columns of pixel units where none of the data lines is disposed, the number of the connecting lines is less than the number of the gaps between the two adjacent columns of pixel units where none of the data lines is disposed (i.e., the positions used for disposing the connecting lines), because the number of the connecting lines is equal to the number of the gate lines. In this case, one connecting line may be disposed at each gap where none of the data lines is disposed, and no connecting line is disposed in a part of the gaps where none of the data lines is disposed. In a case where the number of the gate lines is equal to the number of the gaps between the two adjacent columns of pixel units where none of the data lines is disposed, the number of the connecting lines is equal to the number of the gaps between the two adjacent columns of pixel units where none of the data lines is disposed (i.e., the positions used for disposing the connecting lines), because the number of the connecting lines is equal to the number of the gate lines. In this case, one connecting line may be disposed at each gap where none of the data lines is disposed.

For example, in order to simplify a fabrication process of the array substrate and to reduce fabrication costs of the array substrate, in the above-described array substrate provided by the embodiment of the present disclosure, the respective connecting lines and the respective data lines may be disposed in a same layer, that is, the respective connecting lines and the respective data lines are located in a same film layer and made of a same material, an insulating layer is disposed between the film layer where the respective connecting lines are located and the film layer where the respective gate lines are located, and the respective connecting lines are only electrically connected with the corresponding gate lines through via holes passing through the insulating layer.

For example, in the above-described array substrate provided by the embodiment of the present disclosure, as shown in FIG. 2 and FIG. 3, the respective connecting lines 5 do not overlap with each other, and thus, a problem of short circuit occurring between the respective connecting lines 5 can be avoided.

For example, in order to simplify the fabrication process, in the above-described array substrate provided by the embodiment of the present disclosure, as shown in FIG. 2 and FIG. 3, along an extending direction of the data lines 3, the connecting lines 5 are sequentially electrically connected with the corresponding gate lines 2 respectively, that is, a first connecting line 5 in a first direction (for example, a direction from left to right) is electrically connected with a first gate line 2 in a second direction perpendicular to the first direction (for example, a direction from top to bottom); a second connecting line 5 in the first direction is electrically connected with a second gate line 2 in the second direction, and so on. For example, as shown in FIG. 2, respective via holes 7 are arranged in a straight line.

For example, in order to further simplify the fabrication process, in the above-described array substrate provided by the embodiment of the present disclosure, as shown in FIG. 3, along the extending direction of the data line 3, the respective via holes 7 are staggered sequentially. For example, as shown in FIG. 3, the respective via holes 7 are arranged in a zigzag manner.

Of course, in the above-described array substrate provided by the embodiment of the present disclosure, implementation of electrical connection between the respective connecting lines and the corresponding gate lines is not limited to the structures as shown in FIG. 2 and FIG. 3, but may be other similar structures that can electrically connect the respective connecting lines with the corresponding gate lines, which will not be limited here.

For example, the above-described array substrate provided by the embodiment of the present disclosure, as shown in FIG. 2 and FIG. 3, may further include: data line pins 8 located on the base substrate 1, in one-to one correspondence with and electrically connected with the respective data lines 3. The respective data lines 3 being electrically connected with the data driving circuit through corresponding data line pins 8. In the embodiment shown in FIG. 2 and FIG. 3, the respective data line pins 8 are integrally shown as a rectangular region. The respective data line pins and the gate electrode driving circuit may be disposed in the upper frame region and the lower frame region of the array substrate respectively; or as shown in FIG. 2 and FIG. 3, the respective data line pins 8 and the gate electrode driving circuit 4 may also be disposed in the lower frame region and the upper frame region of the array substrate respectively, that is, the gate electrode driving circuit 4 is located in the upper frame region of the array substrate, and the respective data line pins 8 are located in the lower frame region of the array substrate. Thus, the problem of short circuit occurring between the respective data line pins 8 and the gate electrode driving circuit 4 can be avoided.

An embodiment of the present disclosure further provides a liquid crystal display panel, including the above-described array substrate provided by the embodiment of the present disclosure, the embodiment of the above-described array substrate may be referred to the implementation of the liquid crystal display panel, and repeated parts will not be illustrated here.

An embodiment of the present disclosure further provides a display device, including the above-described liquid crystal display panel provided by the embodiment of the present disclosure, and the display device may be: a mobile phone, a tablet personal computer, a television, a monitor, a laptop computer, a digital photo frame, a navigator, or any other product or part having a display function. The embodiment of the above-described liquid crystal display panel may be referred to for implementation of the display device, and repeated parts will not be illustrated here.

The embodiments of the present disclosure provide an array substrate, a liquid crystal display panel and a display device, the array substrate includes: the base substrate, the plurality of gate lines and the plurality of data lines intersecting with each other and insulated from each other, which are located on the base substrate, and the gate electrode driving circuit located on the base substrate, which is used for driving respective gate lines; wherein, the gate electrode driving circuit is located in the upper frame region or in the lower frame region of the array substrate. As compared with the structure in which the gate electrode driving circuit is located in the left frame region and the right frame region of the array substrate in the related art, the array substrate provided by the embodiments of the present disclosure can enable implement a design of no left frame and no right frame for the array substrate.

Although the present disclosure is described in detail hereinbefore with general illustration and embodiments, based on the present disclosure, certain amendments or improvements can be made thereto, which is obvious for those skilled in the art. Therefore, the amendments or improvements made to the present disclosure without departing from the spirit of the present disclosure should be within the scope of the present disclosure.

The present application claims priority of Chinese Patent Application No. 201510236536.8 filed on May 11, 2015, the disclosure of which is incorporated herein by reference in its entirety as part of the present application.

1. An array substrate, comprising: a base substrate; a plurality of gate lines and a plurality of data lines, on the base substrate, intersecting with each other and insulated from each other; and a gate electrode driving circuit located on the base substrate, configured for providing driving signals for the respective gate lines, wherein, the gate electrode driving circuit is located in an upper frame region or a lower frame region of the array substrate.

2. The array substrate according to claim 1, further comprising: a plurality of connecting lines electrically connected with the respective gate lines in one-to-one correspondence; the respective connecting lines being electrically connected with the gate electrode driving circuit through the corresponding connecting lines.

3. The array substrate according to claim 2, wherein, in a display region of the array substrate, the respective connecting lines are parallel to the respective data lines.

4. The array substrate according to claim 2, further comprising: a plurality of pixel units arranged in matrix on the base substrate;
the connecting lines being disposed at gaps between adjacent columns of the pixel units.

5. The array substrate according to claim 2, further comprising: a plurality of pixel units arranged in a matrix on the base substrate; in each row of the pixel units, two adjacent pixel units being respectively electrically connected with the gate lines located on two sides of this row of pixel units; and two adjacent columns of pixel units being electrically connected with a same data line;
the connecting lines being disposed at gaps between adjacent columns of pixel units where none of the data lines is disposed.

6. The array substrate according to claim 2, wherein, the connecting line and the data line are disposed on a same layer.

7. The array substrate according to claim 2, wherein, the respective connecting lines do not overlap with each other.

8. The array substrate according to claim 2, wherein, along an extending direction of the data lines, the respective connecting lines are sequentially electrically connected with the corresponding gate lines respectively.

9. The array substrate according to claim 2, wherein, the respective connecting lines are electrically connected with the corresponding gate lines through via holes, and the respective via holes are staggered.

10. The array substrate according to claim 1, further comprising: data line pins located on the base substrate, and the data line pins being electrically connected with the respective data lines in one-to-one correspondence;
the respective data line pins and the gate electrode driving circuit being located in the upper frame region and the lower frame region of the array substrate, respectively; or,
the respective data line pins and the gate electrode driving circuit being located in the lower frame region and in the upper frame region of the array substrate, respectively.

11. A liquid crystal display panel, comprising: the array substrate according to claim 1.

12. A display device, comprising: the liquid crystal display panel according to claim 11.
